(19) United States
(12) Patent Application Publication
(10) Pub. No.: US 2007/0029264 A1
(43) Pub. Date: Feb. 8, 2007

(54) Processing biological waste materials to provide energy

(76) Inventor: Michael Joseph Bowe, Lancashire (GB)

Correspondence Address: LAW OFFICES OF WILLIAM H. HOLT, 12311 HARBOR DRIVE, WOODBRIDGE, VA, 22192, US

(21) Appl. No.: 10/557,987

(22) PCT Filed: Jun. 15, 2004
(86) PCT No.: PCT/GB04/02491

§ 371 Date: Nov. 22, 2005

(51) Int. Cl. C02F 1/32

(52) U.S. Cl. 210/748

(57) ABSTRACT

Biological waste materials are mixed with water and subjected to intense ultrasonic irradiation (14), before being supplied to an anaerobic digester (16), so that a biogas is generated which contains methane. The biogas is supplied to a catalytic reformer unit (20) to form a synthesis gas; steam may also be supplied, and the proportion of steam to methane is adjustable so that the synthesis gas may be rich in hydrogen or alternatively rich in carbon monoxide. Adjusting the proportion of steam to biogas enables the output of the process to be adjusted according to market conditions. If the synthesis gas is rich in hydrogen, it may be supplied to a fuel cell (26) to generate electricity, while if it is rich in carbon monoxide, it may be used to generate liquid hydrocarbons in a Fischer-Tropsch synthesis reactor (32).

The present invention relates to a process and an apparatus for processing biological waste materials, which may be based on plant or animal waste products, to provide energy in useful forms such as electricity or hydrocarbon fuel.

The use of anaerobic digestion to produce a biogas from biological waste materials is known, but the resulting gas mixture, which primarily consists of methane and a significant proportion of carbon dioxide, has been perceived as suitable only for combustion to generate heat or electricity. For example JP 2002-336898 A (Ebara) describes a process for treating sludge from a waste water treatment, in which the sludge is treated with ultrasound and then subjected to methane fermentation, so that cells are broken down, and the decomposition rate in the fermentation stage is increased. Similarly, DE 196 15 551 A (Ingan GmbH) describes a multistage anaerobic treatment for a wide range of waste biomass materials, using ultrasound to disrupt cells, and digestion to generate methane; this may also entail warming the waste material and adjusting its pH. The present invention involves the appreciation that biogas may be used as a flexible feedstock so that energy may be provided in a variety of ways.

According to the present invention there is provided a process for treating biological waste materials, the process comprising the steps of:
a) combining the waste materials with water, unless the waste materials already include significant quantities of water;
b) subjecting the waste materials and water to intense ultrasonic irradiation;
c) feeding the irradiated waste materials into an anaerobic digester, so that a biogas is generated containing methane;
characterised by
d) feeding the biogas to a catalytic reformer unit to form a synthesis gas; and
e) adjusting the proportion of steam to methane in the gas mixture in the reformer unit, such that the synthesis gas may be rich in hydrogen or alternatively rich in carbon monoxide.

Adjusting the proportion of steam to methane enables the output of the process to be adjusted according to market conditions. Thus the process preferably includes at least one of the additional steps:
f) if the synthesis gas is rich in hydrogen, supplying it to a fuel cell to generate electricity; or
g) if the synthesis gas is rich in carbon monoxide, supplying it to a Fischer-Tropsch synthesis reactor to generate liquid hydrocarbons.

It will be appreciated that the biogas may contain sulphurous compounds, and it may therefore be desirable to subject the biogas to desulphurisation before it is fed to the catalytic reformer unit.

The invention also provides apparatus for performing the said process.

The invention will now be further and more particularly described by way of example only, and with reference to the accompanying drawings in which;

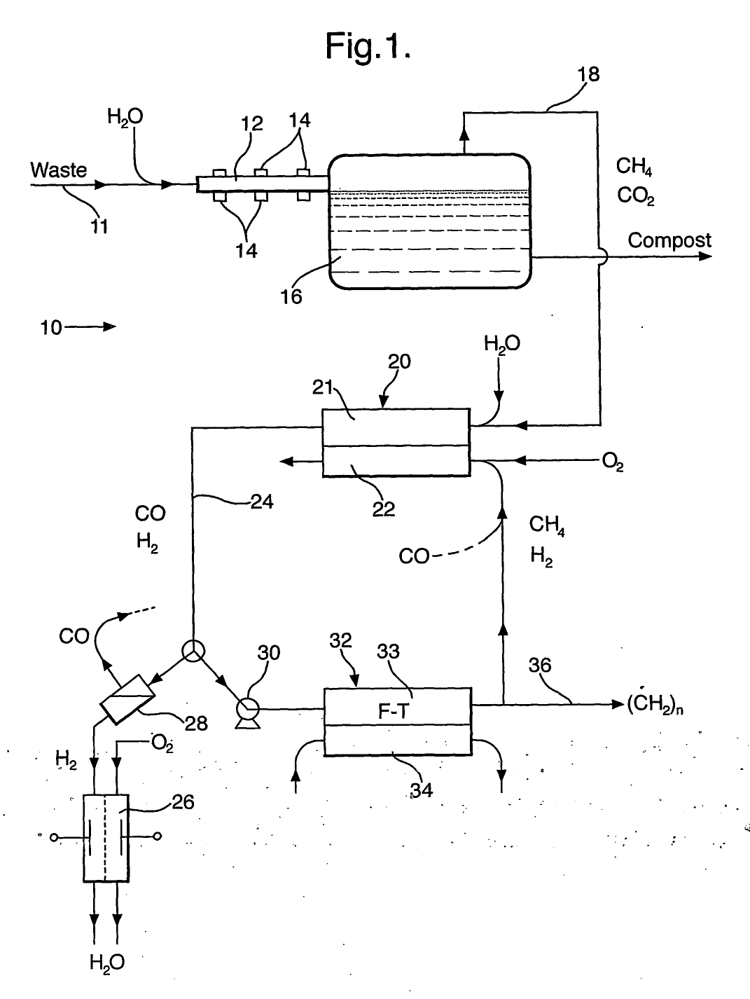

FIG. 1 shows a diagrammatic view of a plant for performing the overall processes of the invention

Referring to FIG. 1, a plant 10 is shown for treating biomass waste to generate energy. A biomass waste stream 11, which may include plant and/or animal waste, is combined with water (unless it is already sufficiently wet) and the mixture is passed through an ultrasonic irradiation duct 12 surrounded by ultrasonic transducers 14 energised so that the mixture is conditioned: the effect of the intense ultrasound may be to break down some of the particulate materials in the waste, and to increase the rate of hydrolysis, and also to release water-soluble nutrients from the waste so that they are more readily accessible to microorganisms. The treated wet waste stream is fed into an anaerobic digester 16. The non-digestible solid materials emerge as a compost, while the bulk of the biodegradable waste material generates a biogas stream 18. This typically comprises between 55 and 60% methane and between 30 and 45% carbon dioxide, with a proportion of water vapour.

Preferably the ultrasonic transducers 14 are attached to the wall of the tube 12 in an array extending both circumferentially and longitudinally, each transducer being connected to a signal generator so that each transducer radiates no more than 3 W/cm², the transducers being sufficiently close together and the number of transducers being sufficiently high that the power dissipation within the vessel is between 25 and 150 W/litre. The values of power given here are those of the electrical power delivered to the transducers, as this is relatively easy to determine. Such an irradiation vessel is described in WO 00/35579. It is desirable to ensure no focusing of the ultrasound occurs, and this may be achieved by energising groups of adjacent transducers in succession. Where the vessel is cylindrical it is particularly preferable to avoid energising diametrically opposite transducers at the same time. The non-focusing can also be achieved by energising adjacent transducers, or adjacent groups of transducers, at different frequencies; and in particular to vary the frequency at which each transducer or group of transducers is energized over a limited range, for example between 19.5 kHz and 20.5 kHz.

The biogas is fed to a compact catalytic reformer 20 in which it flows through a reaction channel 21 kept at an elevated temperature that may for example be 800° C. The first stage involves steam reforming, in which methane reacts with water vapour, that is to say the reaction:
H₂O+CH₄→CO+3 H₂
This reaction is endothermic, and may be catalysed by a rhodium or platinum/rhodium catalyst in the reaction channel 21. The heat required to cause this reaction may be provided by combustion in an adjacent channel 22 of an inflammable gas such as methane or hydrogen, which is exothermic and may be catalysed by a palladium/platinum catalyst. In both cases the catalyst is preferably on a stabilised-alumina support which forms a coating typically less than 100 microns thick on a metal substrate. Both these reactions may take place at atmospheric pressure, although alternatively the reforming reaction might take place at an elevated pressure. The heat generated by the combustion would be conducted through the metal sheet separating the adjacent channels. The steam reforming reaction can be encouraged by adding steam to the biogas stream before it is supplied to the reaction channel 21.

If no steam is added the biogas will undergo the dry reforming reaction:
CO₂+CH₄→2 CO+2 H₂
The proportion of methane that undergoes dry reforming can be enhanced by cooling the biogas stream 18 to condense and remove water vapour. Hence by adjusting the proportion of water added at the inlet to the reaction channel 21, the ratio of hydrogen to carbon monoxide in the resulting synthesis gas stream 24 can be adjusted between about 2:1 to 1:1.

On the other hand, if a larger proportion of water vapour is added then some of the carbon monoxide will undergo the water gas shift reaction, which increases the proportion of hydrogen still further:
CO+H₂O→CO₂+H₂

One option is then to supply the synthesis gas 24 to a fuel cell 26 in which the hydrogen gas reacts indirectly with oxygen from the air to generate electricity and to produce water. In this case reformer 20 should be operated to maximise the proportion of hydrogen in the synthesis gas stream 24. For some types of fuel cell 26, for example a solid oxide cell, the hydrogen/carbon monoxide mixture may be supplied directly to the fuel cell. Alternatively the hydrogen gas may be separated from the other gases using a membrane separation unit 28, for example using a platinum or palladium membrane, or a palladium/copper membrane, so as to generate pure hydrogen gas for use in the fuel cell 26. In this case the fuel cell may be a proton exchange membrane cell. The resulting tail gas, consisting primarily of carbon monoxide, is preferably supplied to the combustion channel 22.

The other option is to subject the synthesis gas 24 to a Fischer-Tropsch synthesis to generate a longer chain hydrocarbon, that is to say a reaction of the type:
n CO+2n H₂→(CH₂)ₙ+n H₂O
which is an exothermic reaction, occurring at an elevated temperature, typically between 190 and 300° C., for example 210° C., and an elevated pressure typically between 2 MPa and 4 MPa, for example 2.5 MPa, in the presence of a catalyst such as cobalt, with a platinum or ruthenium promoter. In this case the synthesis gas stream 24 is compressed by a pump 30 and then supplied to a compact catalytic reactor 32, to flow through reaction channels 33 adjacent to heat exchange channels 34. The exact nature of the organic compounds formed by the reaction depends on the temperature, the pressure, the residence time and the catalyst, as well as the ratio of carbon monoxide to hydrogen. The heat given out by this synthesis reaction may be used to provide at least part of the heat required by the steam/methane reforming reaction, for example a heat transfer fluid may be used to transfer the heat from the reactor 32 and used to preheat at least one of the streams supplied to the reforming reactor 20. The preferred catalyst for the Fischer-Tropsch synthesis comprises a coating of lanthanum-stabilised gamma-alumina with about 10-40% cobalt (by weight compared to the alumina), and with a ruthenium/platinum promoter which is less than 10% the weight of the cobalt, and with a basicity promoter such as gadolinium oxide which may be less than 5% the weight of the cobalt.

The gas stream emerging from 30 Fischer-Tropsch reactor 32 will contain hydrocarbons of a range of different molecular weights, and also water vapour. These may be condensed to provide the desired high molecular weight hydrocarbons as an output stream 36. The low molecular weight tail gases (consisting primarily of hydrogen, methane and ethane) are supplied to the combustion channel 22 of the reforming reactor 20. The water that also condenses may be separated from the hydrocarbons and may be returned to the digester 16.

If the biogas stream 18 contains any sulphur-containing compounds it is preferably desulphurised before reaching the reforming reactor 20. This may involve a liquid scrubbing absorption, for example using an aqueous solution of a chelated ferric salt. This converts the ferric salt to the ferrous form; the solution can be recirculated through an air scrubber to regenerate the ferric salt and to form a precipitate of sulphur. Alternatively, it may use a desulphurisation technique that requires elevated temperatures, for example a solid state absorption process.

A benefit of subjecting the waste stream 11 to intense ultrasound is that the bio-availability of plant cellulose is increased by disrupting lignin layers, so that the rate of digestion in the digester 16 is increased and that the waste stream may contain significant proportions of woody material containing lignin. The process is particularly suited to treating wet organic materials, as no drying is required and indeed in some cases no water will need to be added. The ultrasound enhances the rate of digestion so that the retention time in the digester 16 is reduced and consequently a smaller digester 16 can be used to treat a given quantity of waste material.

It will be appreciated that both the fuel cell 26 and the digester 16 also generate heat. This heat may itself be useful, for example for community heating.

The plant 10 shown in FIG. 1 might for example be used to treat 20 tonnes of organic waste of approximately 15% by weight of solids, and to produce about seven barrels per day of synthetic high-quality hydrocarbon that may be converted to automotive fuel use.

1. A process for treating biological waste materials, the process comprising the steps of:
a) combining the waste materials with water, unless the waste materials already include significant quantities of water;
b) subjecting the waste materials and water to intense ultrasonic irradiation;
c) feeding the irradiated waste materials into an anaerobic digester, so that a biogas is generated containing methane and carbon dioxide;
characterised by
d) feeding the biogas containing methane and carbon dioxide to a catalytic reformer unit to form a synthesis gas;
e) supplying synthesis gas to a Fischer-Tropsch synthesis reactor to generate liquid hydrocarbons; and
f) adjusting the proportion of steam to methane in the gas mixture in the reformer unit.

2. A process as claimed in claim 1 that also includes the additional step:
g) if the synthesis gas is rich in hydrogen, supplying the synthesis gas to a fuel cell to generate electricity,

3. A process as claimed in claim 1 wherein the biogas is subjected to desulphurisation before it is fed to the catalytic reformer unit.

4. A process as claimed in claim 1 wherein the biogas is cooled to condense and separate water vapour from it, before it is fed to the catalytic reforming unit.

5. A plant for treating biological waste materials, the plant compriing:
a) means to combine the waste materials with water, unless the waste materials already include significant quantities of water;
b) an ultrasonic irradiator to subject the waste materials and water to intense ultrasonic irradiation;
c) an anaerobic digester for digesting the ultrasonically irradiated waste materials so that a biogas is generated that contains methane and carbon dioxide;
characterised by
d) a catalytic reformer unit to form a synthesis gas, to which biogas containing methane and carbon dioxide from the digester is supplied;
e) a Fischer-Tropsch synthesis reactor to generate liquid hydrocarbons from synthesis gas: and
f) means to adjust the proportion of steam to methane in the gas mixture in the reformer unit.

6. A plant as claimed in claim 5 that also includes:
g) a fuel cell to generate electricity; and
h) means to control the proportions of the synthesis gas supplied to the fuel cell or to the Fischer-Tropsch synthesis reactor.

7. A plant as claimed in claim 5 also comprising means to remove water vapour from the biogas supplied to the reformer unit, so as to further adjust the proportion of steam to methane undergoing reforming.
